(19) United States
(12) Patent Application Publication
(10) Pub. No.: US 2006/0255151 A1
(43) Pub. Date: Nov. 16, 2006

(54) Optical switch structured of a barcode scanner

(76) Inventor: Kai-Yuan Tien, Taipei (TW)

Correspondence Address: LEONG C LEI, PMB # 1008, 1867 YGNACIO VALLEY ROAD, WALNUT CREEK, CA, 94598, US

(21) Appl. No.: 10/383,723

(22) Filed: Mar. 10, 2003

(51) Int. Cl. G06K 7/10

(52) U.S. Cl. 235/462.48

(57) ABSTRACT

An optical switch structure of a barcode scanner having a casing includes a wheel center fixedly mounted on an axle and partially protruding out of the scanner casing as a rotated switch, a light shield provided on the wheel or mounted on the axle linked to the wheel, the light shield having a plurality of radial slots, and a U-shaped photo interrupter having two upwardly extending arms with a photodiode light emitter and a phototransistor light receiver inside disposed on either arm, the U-shaped photo interrupter being installed under the light shield so that the photodiode light emitter is disposed at one side of the light shield and the phototransistor light receiver is disposed at the opposite side of the light shield, whereby when the wheel is rotated, the light shield will be rotated simultaneously thereby intermittently blocking light transmitting from the photodiode light emitter to the phototransistor light receiver and therefore converting light signals into pulse signals to turn on the barcode scanner.

### BACKGROUND OF THE INVENTION

1. Field of the Invention

This invention is related to an optical switch structure of a barcode scanner, and in particular to one optical switch which does not have conductive contact points thereby facilitating operation and prolonging the lifetime of the barcode scanner.

2. Description of the Prior Art

As shown in FIGS. 1, 2 and 3, the conventional barcode scanners 1, 2 and 3 are with different appearances and designed to be held by one hand to read barcodes. The barcode scanners are generally used in two ways, i.e. one by means of no scanning light being provided until the barcode scanner is turned on, and the other by means of the scanning light being provided constantly. The first kind of barcode scanners will power on the circuit, provide scanning light, receive the barcode image and read the information from the barcode image when it is turned on, whereas the second of barcode scanners will maintain some power for some component parts normally and then will receive the barcode image, read the information from the barcode image when it is turned on. No matter which kind of barcode scanners, the switches 11, 21 and 31 are either provided at the lower side (see FIG. 1), the lateral side (see FIG. 2) or on the top (see FIG. 3). Since the switches belong to the press-button-type, they will be oxidized on the conductive contact points after operating for a certain period of time thereby causing incomplete contact and therefore influencing the performance of the scanner. In the meantime, a data collector 4 with a switch 41 as shown in FIG. 4 has been developed, but has the same drawback mentioned above. However, the switch 41 is still unsatisfactorily in use.

Therefore, it is an object of the present invention to provide an optical switch structure of a barcode scanner which can obviate and mitigate the above-mentioned drawbacks.

### SUMMARY OF THE INVENTION

This invention is related to an optical switch structure of a barcode scanner, which does not have conductive contact points thereby facilitating operation and prolonging the lifetime of the barcode scanner.

It is the primary object of the present invention to provide an optical switch structure of a barcode scanner having a casing includes a wheel center fixedly mounted on an axle and partially protruding out of the scanner casing as a rotated switch, a light shield provided on the wheel or mounted on the axle linked to the wheel, the light shield having a plurality of radial slots, and a U-shaped photo interrupter having two upwardly extending arms with photodiode light emitter and phototransistor light receiver inside disposed on either arm, the U-shaped photo interrupter being installed under the light shield so that photodiode light emitter is disposed at one side of the light shield and the phototransistor light receiver is disposed at the opposite side of the light shield, whereby when the wheel is rotated, the light shield will be rotated simultaneously thereby intermittently blocking light transmitting from the photodiode light emitter to the phototransistor light receiver and therefore converting light signals into pulse signals to turn on the barcode scanner.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a first prior art barcode scanner;

FIG. 2 is a perspective view of a second prior art barcode scanner;

FIG. 3 is a perspective view of a third prior art barcode scanner;

FIG. 4 is a perspective view of a prior art data collector;

FIG. 5 is a perspective view of a first preferred embodiment according to the present invention;

FIG. 6 is a perspective view of a second preferred embodiment according to the present invention;

FIG. 7 is a perspective view of a third preferred embodiment according to the present invention;

FIG. 8 is a perspective view of a data collector equipped with the optical switch structure according to the present invention;

FIG. 9 illustrates the optical switch structure according to a first preferred embodiment according to the present invention;

FIG. 9A illustrates the optical switch structure according to a second preferred embodiment according to the present invention;

FIG. 10 illustrates the working principle of the present invention;

FIG. 11 illustrates the optical switch structure according to a third preferred embodiment according to the present invention; and

FIG. 12 illustrates the optical switch structure according to a fourth preferred embodiment according to the present invention.

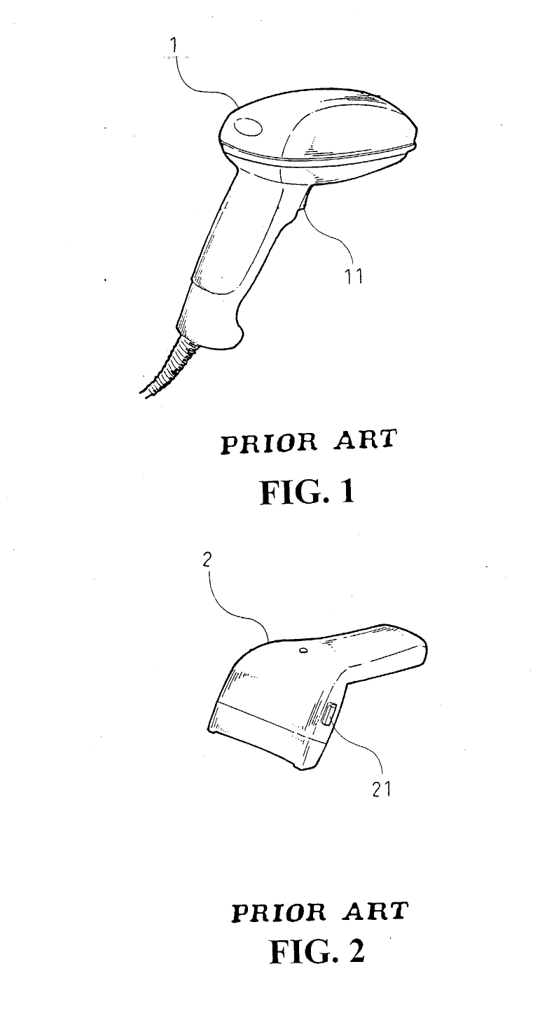

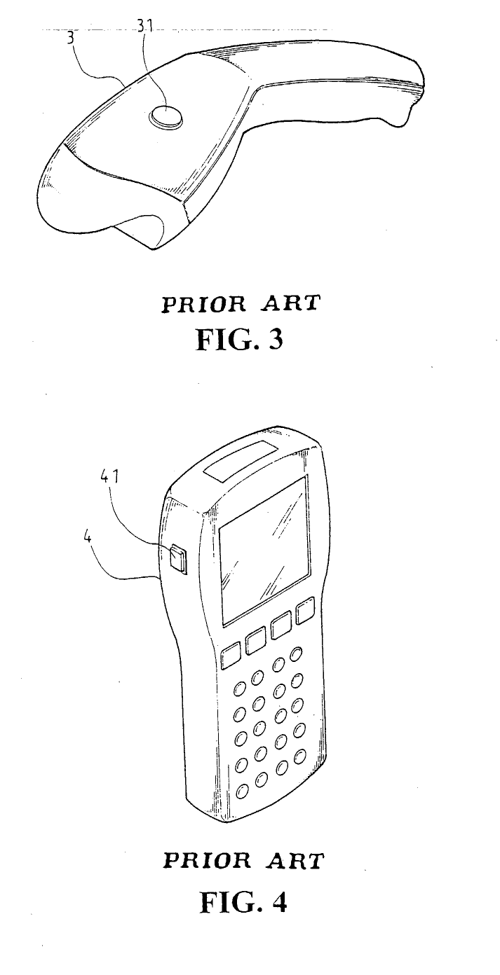

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

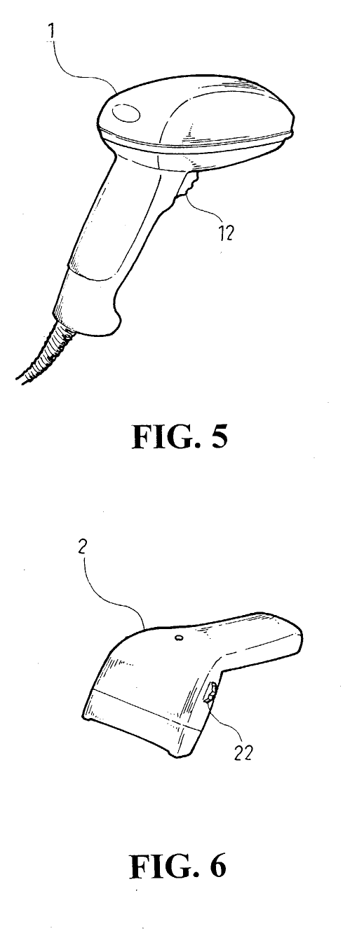

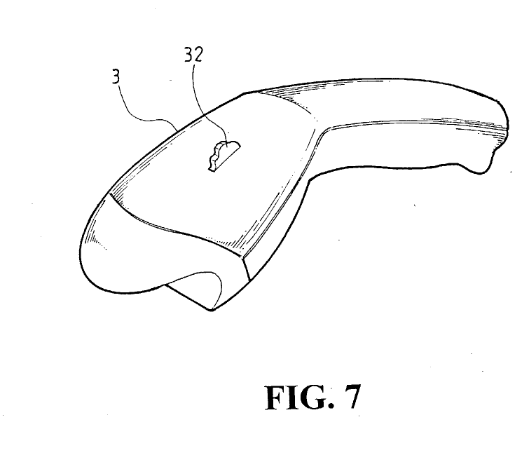

With reference to the drawings and in particular to FIGS. 5, 6 and 7 thereof, wheels 12, 22 and 32 are provided on the lower portion, the lateral side and the top of barcode scanners 1, 2 and 3, respectively. The wheels 12, 22 and 32 partially protrude out of the casings of the barcode scanners 1, 2 and 3, respectively, so that a user can easily turn the wheels 12, 22 and 32 to turn on the scanning light of the barcode scanners 1, 2 and 3.

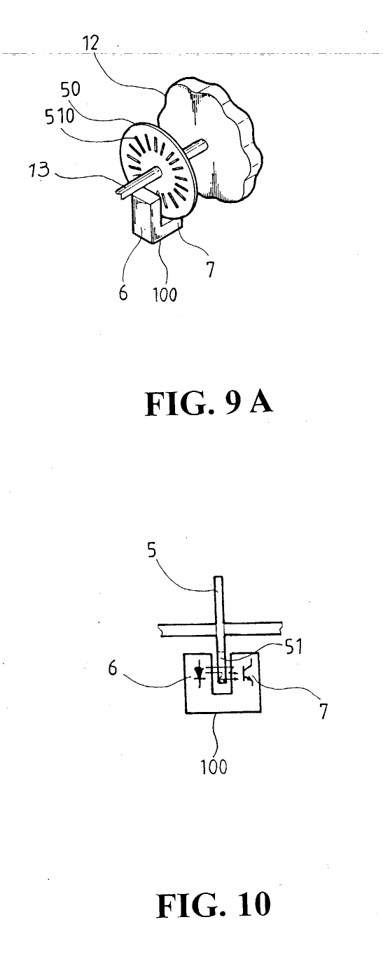

Referring to FIGS. 9 and 10, the center of the wheel 12 is mounted on an axle 13 and the wheel 12 is provided with a light shield 5 having a plurality of radial slots 51. AU-shaped photo interrupter 100, which has two upwardly extending arms with a photodiode light emitter 6 and a phototransistor light receiver 7 inside disposed on either arm, is installed under the wheel 12 so that the photodiode light emitter 6 is disposed at one side of the light shield 5 and the phototransistor light receiver 7 is disposed at the opposite side of the light shield 5. As the wheel 12 is rotated, the light shield 5 will be rotated simultaneously thereby intermittently blocking light transmitting from the photodiode light emitter 6 to the phototransistor light receiver 7 and therefore converting light signals into pulse signals. The barcode scanner is set to operate when a pulse signal is picked up within a predetermined period of time.

FIG. 9A illustrates another preferred embodiment of the present invention. As shown, a light shield 50 with a plurality of radial slots 510 is mounted on the axle 13 linked to the wheel.

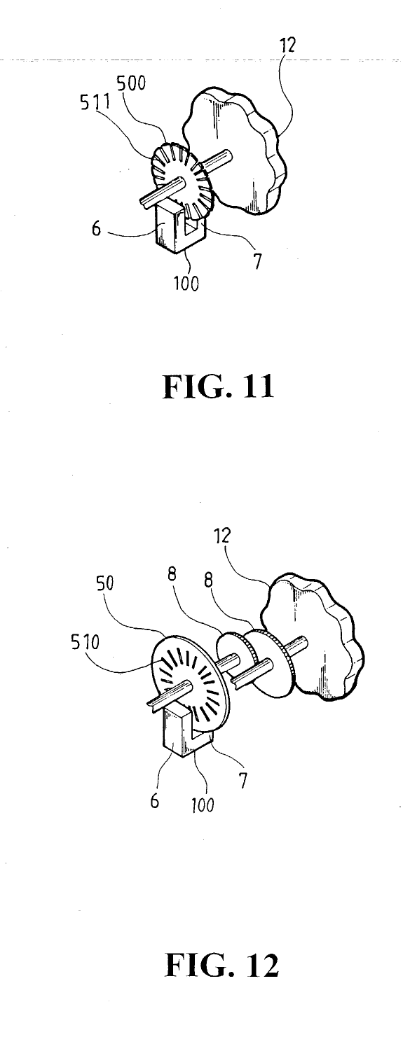

FIG. 11 illustrates a third preferred embodiment of the present invention. As illustrated, the light shield 500 is formed with a plurality of radial slots 511 with open ends.

FIG. 12 is a perspective view of a fourth preferred embodiment of the present invention. As shown, the wheel 12 may be drivingly connected with the light shield 50 via a reduction gearing consisting of a number of gears 8 so as to decrease the speed.

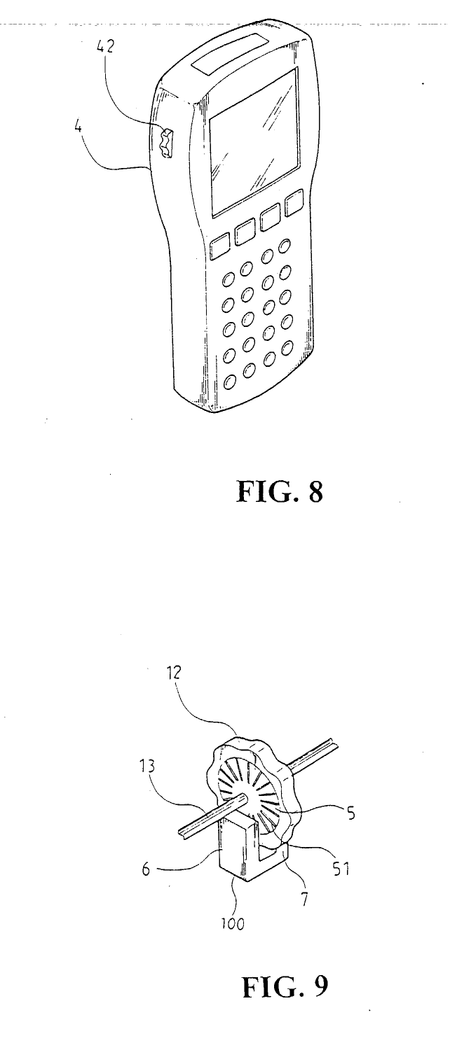

As shown in FIG. 8, the present invention can be applied to a data collector 4 having a wheel 42 partially protruding out the casing, so that the data collector 4 can be turned on by rotating the wheel 42.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An optical switch structure of a barcode scanner having a casing, comprising:
a wheel center fixedly mounted on an axle and partially protruding out of the scanner casing as a rotated switch;
a light shield provided on said wheel;
said light shield having a plurality of radial slots; and
a U-shaped photo interrupter having two upwardly extending arms with photodiode light emitter and phototransistor light receiver inside disposed on either arm, said U-shaped photo interrupter being installed under said light shield so that said photodiode light emitter is disposed at one side of said light shield and said phototransistor light receiver is disposed at the opposite side of said light shield;
whereby when said wheel is rotated, said light shield will be rotated simultaneously thereby intermittently blocking light transmitting from said photodiode light emitter to said phototransistor light receiver and therefore converting light signals into pulse signals to turn on said barcode scanner.

2. The optical switch structure of a barcode scanner as claimed in claim 1, wherein said wheel can be mounted on any appropriate position of the barcode scanner.

3. The optical switch structure of a barcode scanner as claimed in claim 1, wherein said light shield is mounted on said axle linked to said wheel instead being provided on said wheel.

4. The optical switch structure of a barcode scanner as claimed in claim 1, further comprising a reduction gearing between said wheel and said light shield.

5. The optical switch structure of a barcode scanner as claimed in claim 1, wherein said radial slots have open ends.
